(19) United States
(12) Patent Application Publication
(10) Pub. No.: US 2026/0349243 A1
(43) Pub. Date: Nov. 5, 2026

(54) SCANNING DEVICE AND SCANNING DISPLAY MODULE

(71) Applicant: ChengDu IDEALSEE Technology Co., Ltd., Chengdu (CN)

(72) Inventors: Xiaohu LI, Chengdu (CN); Changcheng YAO, Chengdu (CN); Haitao SONG, Chengdu (CN)

(21) Appl. No.: 19/739,471

(22) Filed: Jul. 13, 2026

Related U.S. Application Data
(63) Continuation-in-part of application No. 17/818,288, filed on Aug. 8, 2022.
Application No. 17/818,288 is a continuation of application No. PCT/CN2022/100438, filed on Jun. 22, 2022.

(30) Foreign Application Priority Data
Sep. 18, 2021 (CN) 202111127410.9

(51) Int. Cl. G02B 26/10; H04N 9/31

(52) U.S. Cl. CPC G02B 26/103; H04N 9/3135

(57) ABSTRACT

A scanning device and a scanning display module are provided. Through a structural design of an actuator, first-order and second-order bending mode natural frequencies of the actuator of the scanning device in a vibration direction satisfy a set condition. When an optical fiber is fixed to the actuator, a ratio of a resonance frequency of the optical fiber in the vibration direction to the bending mode frequency of the actuator in the vibration direction is within a first numerical range. An interval between a natural frequency of the optical fiber and the first-order bending mode natural frequency of the actuator in the vibration direction is within a second numerical range.

### CROSS REFERENCE TO RELATED APPLICATIONS

The present application is a continuation in part application of U.S. application Ser. No. 17/818,288 filed on Aug. 8, 2022, and titled “SCANNING DEVICE, DRIVING CONDITION SETTING METHOD, AND SCANNING DISPLAY MODULE”, which is a Continuation of PCT application No. PCT/CN2022/100438 filed on Jun. 22, 2022, claims the priority to Chinese Application No. 202111127410.9 filed on Sep. 18, 2021, which are in incorporated herein by reference in their entireties.

### TECHNICAL FIELD

This disclosure relates to the field of display technologies, in particular, to a scanning device and a scanning display module.

### BACKGROUND

Laser scanning display, as a new display imaging technology, can implement scanning display by using a scanning device, for example, a micro-electro-mechanical system (MEMS) scanning mirror or a fiber scanner (for brevity, “optical fiber”). The technology may be applied to a plurality of display scenarios such as projection display and near-eye display.

In practical applications, to achieve a good display effect, the scanning device is in a high-frequency vibration state and becomes a complex vibration system. Therefore, it is necessary to improve designs of characteristics and driving conditions of the scanning device.

### SUMMARY

In view of this, a scanning device and a scanning display module are provided, to improve performance of the scanning device. Based on one aspect of this disclosure, a scanning device is provided. The scanning device may include: a support base; an actuator, where the actuator has a width, a length, and a thickness, the width is greater than the thickness, the actuator includes a back end and a free end, the back end is fixed to the support base, and the free end extends in a length direction from the back end towards a direction away from the support base and is narrowed in a contracting manner to form an end portion; and an optical fiber fixed to the actuator, where after the optical fiber is fixed to the actuator, the part extending beyond the actuator in the length direction forms an optical fiber cantilever.

The actuator drives the optical fiber fixed to the actuator to vibrate in a first direction under the drive of a driving signal, where the first direction is a thickness direction.

Based on a second aspect of this disclosure, a scanning device is provided. The scanning device includes a support base, an actuator, and an optical fiber fastened on the actuator, where the actuator includes a back end and a front end, the back end is fixedly supported on the support base, and the front end is a free end; the actuator extends along a length direction towards a direction away from the back end, and a dimension of the actuator gradually decreases in at least one of a width direction and a thickness direction to form the front end; the optical fiber extends along the length direction and is fixed to the actuator, and the thickness direction is a first direction; the actuator drives the optical fiber to vibrate in the first direction under the drive of a driving signal; and the actuator is configured such that first-order and second-order bending mode natural frequencies in the first direction satisfy a set condition: Fp2>2Fp1, where Fp1 is the first-order bending mode natural frequency of the actuator in the first direction; and Fp2 is the second-order bending mode natural frequency of the actuator in the first direction.

Based on a third aspect of this disclosure, a scanning device is provided, including a support base, an actuator, and an optical fiber fastened on the actuator, where the actuator includes a back end and a front end, the back end is fixedly supported on the support base, and the front end is a free end; the actuator extends along a length direction towards a direction away from the back end, and a dimension of the actuator gradually decreases in at least one of a width direction and a thickness direction to form the front end;
the optical fiber extends along the length direction and is fixed to the actuator, and the thickness direction is a first direction; the actuator drives the optical fiber to vibrate in the first direction under the drive of a driving signal; the optical fiber is configured in the length direction at the front end of the actuator such that an end face of the optical fiber does not extend beyond an end face of the front end of the actuator; and the actuator is configured such that first-order and second-order bending mode natural frequencies in the first direction satisfy a set condition: Fp2>2Fp1, where Fp1 is the first-order bending mode natural frequency of the actuator in the first direction; and Fp2 is the second-order bending mode natural frequency of the actuator in the first direction.

Based on a fourth aspect of this disclosure, a scanning display module is provided. The scanning display module includes at least the scanning device provided in the first or second aspect of this disclosure, a light source, and a control circuit.

Under the control of the control circuit, the light source outputs image light, and then the scanning device outputs the image light to implement scanning display.

According to the scanning device and the scanning display module provided in the embodiments of this disclosure, through the structural design of the actuator, the first-order and second-order bending mode natural frequencies of the actuator of the scanning device in the vibration direction satisfy the set condition. After the optical fiber is fixed to the actuator, a ratio of a resonance frequency of the optical fiber in the vibration direction to the bending mode frequency of the actuator in the vibration direction is within a first numerical range. An interval between a natural frequency of the optical fiber and the first-order bending mode natural frequency of the actuator in the vibration direction is within a second numerical range. In this case, when the scanning device is driven by the resonance frequency in the first direction, the occurrence of a vibration component of the optical fiber in a direction perpendicular to the vibration direction can be avoided, where the vibration component will cause a scanning trajectory of a fiber scanner to no longer be a straight line, but rather to exhibit a nonlinear trajectory, resulting in severe interference with the actual imaging effect. The fiber scanner is enabled to achieve a good scanning display effect.

### BRIEF DESCRIPTION OF DRAWINGS

Other features, objectives, and advantages of this disclosure will become more apparent by reading detailed descriptions of non-limitative embodiments provided with reference to the following drawings:

FIG. 1a is a schematic diagram of a structure of a scanning device referred to as a fiber scanner according to an embodiment of this disclosure;

FIG. 1b is a schematic diagram of a structure of an actuator in FIG. 1a;

FIG. 1c is a schematic diagram of a structure and a deformation state of an actuator composed of a single layer of piezoelectric sheet according to an embodiment of this disclosure;

FIG. 1d is a schematic diagram of a structure of an actuator composed of dual piezoelectric sheets according to an embodiment of this disclosure;

FIG. 1e is a schematic diagram of a structure of another actuator composed of dual piezoelectric sheets according to an embodiment of this disclosure;

FIG. 1f is a schematic diagram of a structure of an actuator composed of multiple layers of piezoelectric sheets according to an embodiment of this disclosure;

FIG. 2a is a schematic diagram of a structure of a scanning device 20 according to an embodiment of this disclosure;

FIG. 2b is a variant example based on FIG. 2a;

FIG. 2c is a schematic diagram of a buffer structure of an actuator according to an embodiment of this disclosure;

FIG. 3 is a schematic diagram of a structure of a scanning device 30 according to an embodiment of this disclosure;

FIG. 4 is a variant example of an actuator 11 according to an embodiment of this disclosure;

FIG. 5a is a cross-sectional schematic diagram of a scanning device according to an embodiment of this disclosure;

FIG. 5b is a cross-sectional schematic diagram of a scanning device according to an embodiment of this disclosure;

FIG. 5c is a cross-sectional schematic diagram of a scanning device according to an embodiment of this disclosure;

FIG. 6a is a schematic diagram of a structure of a scanning device 20 according to an embodiment of this disclosure;

FIG. 6b is a schematic diagram of a structure of a scanning device 20 according to an embodiment of this disclosure;

FIG. 7a is a spectrogram of a scanning device according to an embodiment of this disclosure;

FIG. 7b is a spectrogram of a scanning device according to an embodiment of this disclosure;

FIG. 8a is a trajectory diagram of an optical fiber cantilever at 3600 mm in a scanning device according to an embodiment of this disclosure;

FIG. 8b is an impedance curve diagram corresponding to a state in FIG. 8a;

FIG. 9a is a trajectory diagram of an optical fiber cantilever at 3500 mm in a scanning device according to an embodiment of this disclosure;

FIG. 9b is an impedance curve diagram corresponding to a state in FIG. 9a;

FIG. 10a is a trajectory diagram of an optical fiber cantilever at 3400 mm in a scanning device according to an embodiment of this disclosure;

FIG. 10b is an impedance curve diagram corresponding to a state in FIG. 10a;

FIG. 11a is a trajectory diagram of an optical fiber cantilever at 3300 mm in a scanning device according to an embodiment of this disclosure;

FIG. 11b is an impedance curve diagram corresponding to a state in FIG. 11a;

FIG. 12a is a trajectory diagram of an optical fiber cantilever at 3200 mm in a scanning device according to an embodiment of this disclosure;

FIG. 12b is an impedance curve diagram corresponding to a state in FIG. 12a;

FIG. 13a is a trajectory diagram of an optical fiber cantilever at 3100 mm in a scanning device according to an embodiment of this disclosure;

FIG. 13b is an impedance curve diagram corresponding to a state in FIG. 13a;

FIG. 14a is a trajectory diagram of an optical fiber cantilever at 3000 mm in a scanning device according to an embodiment of this disclosure;

FIG. 14b is an impedance curve diagram corresponding to a state in FIG. 14a;

FIG. 15a is a trajectory diagram of an optical fiber cantilever at 2900 mm in a scanning device according to an embodiment of this disclosure;

FIG. 15b is an impedance curve diagram corresponding to a state in FIG. 15a;

FIG. 16a is a trajectory diagram of an optical fiber cantilever at 2800 mm in a scanning device according to an embodiment of this disclosure;

FIG. 16b is an impedance curve diagram corresponding to a state in FIG. 16a;

FIG. 17a is a trajectory diagram of an optical fiber cantilever at 2700 mm in a scanning device according to an embodiment of this disclosure;

FIG. 17b is an impedance curve diagram corresponding to a state in FIG. 17a;

FIG. 18a is a trajectory diagram of an optical fiber cantilever at 2600 mm in a scanning device according to an embodiment of this disclosure;

FIG. 18b is an impedance curve diagram corresponding to a state in FIG. 18a;

FIG. 19a is a trajectory diagram of an optical fiber cantilever at 2500 mm in a scanning device according to an embodiment of this disclosure;

FIG. 19b is an impedance curve diagram corresponding to a state in FIG. 19a;

FIG. 20a is a trajectory diagram of an optical fiber cantilever at 2400 mm in a scanning device according to an embodiment of this disclosure;

FIG. 20b is an impedance curve diagram corresponding to a state in FIG. 20a;

FIG. 21a is a trajectory diagram of an optical fiber cantilever at 2300 mm in a scanning device according to an embodiment of this disclosure;

FIG. 21b is an impedance curve diagram corresponding to a state in FIG. 21a;

FIG. 22a is a trajectory diagram of an optical fiber cantilever at 2300 mm in a scanning device according to an embodiment of this disclosure; and

FIG. 22b is an impedance curve diagram corresponding to a state in FIG. 22a.

### DETAILED DESCRIPTION

The following further describes this disclosure in detail with reference to the drawings and embodiments. It may be understood that specific embodiments described herein are only used to explain the related disclosure, but not to limit this disclosure. It should also be noted that, for ease of description, only parts related to the related disclosure are shown in the drawings.

In order to facilitate understanding and clearly express contents of technical solutions of this disclosure, in the embodiments of this disclosure, technical contents are described with reference to an xyz coordinate system shown in the drawings. In the coordinate system, a direction parallel to an X-axis may also be referred to as an X-axis direction, a first direction, a longitudinal direction, or an up-down direction; a direction parallel to a Y-axis may also be referred to as a Y-axis direction, a second direction, a transverse direction, or a left-right direction; a direction perpendicular to an XY plane may be regarded as a Z-axis direction; and a direction parallel to a Z-axis may also be referred to as the Z-axis direction, a third direction, or the length direction. The coordinate system is employed in different drawings or embodiments of this disclosure, and descriptions of corresponding direction names are also applicable throughout.

In the embodiments of this disclosure, descriptions of frequency conditions and frequency characteristics are involved.

The frequency conditions may include numerical ranges and specific values of a driving frequency, an actuator natural frequency, and an optical fiber natural frequency, and the like.

The frequency characteristics may include the foregoing frequency conditions, a relationship between the actuator natural frequency and the optical fiber natural frequency, a relationship between the driving frequency and the actuator natural frequency, a relationship between the driving frequency and the optical fiber natural frequency, and the like.

In the embodiments of this disclosure, a scanning device is first provided. The scanning device includes: a support base, an optical fiber, and an actuator, where the actuator includes a back end and a front end, the back end is fixedly supported on the support base, and the front end is a free end; the actuator extends along a length direction towards a direction away from the back end, and a dimension of the actuator gradually decreases in at least one of a width direction and a thickness direction to form the front end; the optical fiber is fixed to the actuator, a light output end of the optical fiber is disposed near the front end of the actuator, and is configured to emit light beams forward along the length direction; and the actuator is configured to drive the optical fiber to vibrate in a first direction in response to a driving signal, where the first direction is the thickness direction.

In an optional implementation, the entire actuator is of a sheet structure, and the dimension of an end portion of the actuator in the width direction is greater than that in the thickness direction.

In an optional implementation, the dimension of the actuator in the width direction gradually decreases forward along the length direction to form the front end; or the dimension of the actuator in the width direction decreases smoothly forward along the length direction to form the front end.

In an optional implementation, the optical fiber extends along the length direction, and is fixed to at least one of two main surfaces of the actuator that are opposite to each other along the thickness direction.

In an optional implementation, the actuator has a through channel along the length direction, and the optical fiber is disposed through the through channel and fixedly connected to the actuator.

In an optional implementation, the dimension of the front end in the width direction is less than that in the thickness direction, and the dimension in the width direction corresponds to a diameter of the optical fiber.

In an optional implementation, the through channel is provided with a buffer structure at the front end, and the buffer structure includes a tapered opening extending from a first position at a first distance from the through channel to a plane in which the front end is located to the plane in which the front end is located, so that an opening dimension of the through channel on the plane in which the front end is located is greater than that of the through channel at the first position.

In an optional implementation, the light output end of the optical fiber extends beyond the front end of the actuator to form an optical fiber cantilever; or the light output end of the optical fiber is flush with an end face of the front end of the actuator.

In an optional implementation, at least part of the front end of the actuator is made of a second material, and the remaining part of the actuator is made of a first material.

In an optional implementation, an axis of the light output end of the optical fiber is parallel to a central axis of the actuator along the length direction, where the central axis is an axis passing through a geometric center and/or a center of mass of the actuator. In this implementation, the axis of the light output end of the optical fiber may incompletely coincide with the central axis of the actuator along the length direction. This considers actual engineering assembly errors and provides corresponding tolerances.

In one or more embodiments, a plane which is perpendicular to the width direction and in which the axis of the light output end of the optical fiber is located is coplanar with a plane which is perpendicular to the width direction and in which the central axis of the actuator along the length direction is located.

In an optional implementation, a cross-section of the front end perpendicular to the length direction is rectangular, elliptical, or isosceles trapezoidal.

The following, in conjunction with the drawings, provides a further detailed description of the scanning device and frequency characteristics in this disclosure. It may be understood that the specific embodiments described herein are only used to explain the related disclosure, but not to limit this disclosure. It should also be noted that, for ease of description, only the parts related to the related disclosure are shown in the drawings.

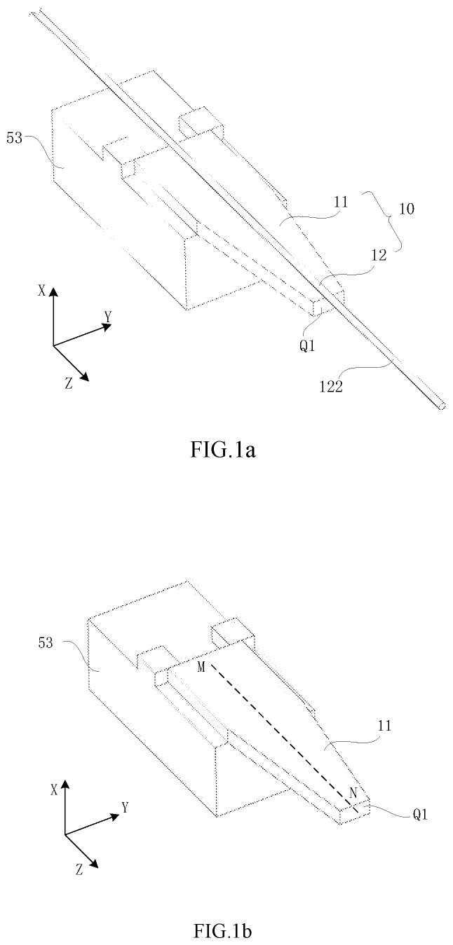

With reference to FIG. 1a and FIG. 1b, an exemplary scanning device 10 and a support base 53 for fixing the scanning device 10 in an embodiment of this disclosure are shown. The scanning device 10 mainly includes an actuator 11 and an optical fiber 12. The scanning device 10 is also referred to as a fiber scanner. In this example, one end of the actuator 11 is fixed to the support base 53 (this end may be referred to as a back end), and the other end is free in space and not connected to an external fixing structure (this end may be referred to as a front end/free end). The entire actuator 11 is sheet-like. The actuator in such a structural form may also be referred to as a sheet-like actuator. The dimension of the actuator in the thickness direction is less than that in the width direction. The part of the actuator 11 that extends beyond the support base 53 is wedge-shaped. That is, a cross-sectional dimension, taken perpendicular to a YZ plane, of the part of the actuator 11 that extends beyond the support base 53 gradually decreases in the back-front direction, and after decreasing to a certain degree, an end face (that is, a front end face Q1 shown in FIG. 1a and FIG. 1b) is formed at the front end of the actuator 11. The front end face Q1 of the actuator 11 has a certain dimension in the width direction (such as several to dozens of times a dimension of a conventional optical fiber core), and width surfaces of the actuator 11 (surfaces of the actuator 11 in the width direction, including an upper surface and a lower surface, which may also be referred to as “two main surfaces opposite along the thickness direction”) are flat. Such a structural form of the end facilitates, on the one hand, the fixing of the optical fiber 12, thereby reducing engineering difficulty when the optical fiber 12 is fixed (as shown in FIG. 1a, the optical fiber 12 is fixed to the upper surface of the actuator 11). On the other hand, the structural form enables the actuator 11 to possess specific frequency characteristics, so that stable vibration performance can be obtained when the actuator 11 is in operation. Certainly, the dimension of the end face will affect vibration frequencies of the actuator 11, but the dimension of the end face is not limited in the embodiments of this disclosure. Meanwhile, it should be understood that the actuator 11 will satisfy frequency conditions set forth below, and contents of related frequency characteristics will be described in detail below.

In this example, the actuator 11 has an axisymmetric structure. Specifically, with reference to FIG. 1b, a structural form of the actuator 11 in the width direction is symmetrical about a plane that passes through a central axis MN and is parallel to an X-axis, and a structural form in the thickness direction is symmetrical about a plane that passes through the central axis MN and is parallel to a Y-axis. The central axis MN described here is distributed along the length direction of the actuator 11. In some embodiments, the structural form of the actuator 11 is axisymmetric only in one direction. In some other embodiments, the actuator 11 does not have an axisymmetric structure. Therefore, in the embodiments of this disclosure, the central axis may be regarded as an axis passing through the geometric center and/or the center of mass of the actuator.

In this example, the optical fiber 12 shown in FIG. 1a is disposed on the upper surface of the actuator 11 and may be fixed by bonding or welding, or through a support base, or the like. The optical fiber 12 may be entirely fixed to the upper surface of the actuator 11, or partially fixed to the upper surface of the actuator 11. When partially fixed, the part of the optical fiber 12 in contact with the front end of the actuator 11 is taken as a fixing point for fixing. Usually, after fixed, the axis of the light output end of the optical fiber 12 is parallel to the central axis of the actuator 11 along the length direction (such as the central axis MN). In one or more embodiments, when the optical fiber 12 is disposed on the upper surface of the actuator 11, the position of the optical fiber 12 coincides with a projection of a symmetry axis (such as the central axis MN) of the actuator 11 in the length direction on the upper surface. In some embodiments, the position of the optical fiber 12, when disposed on the upper surface of the actuator 11, may not be associated with the symmetry axis of the actuator 11 in the length direction. The optical fiber 12 is disposed along a length axis direction of the actuator 11 and extends at the front end of the actuator 11, to form a cantilevered structure 122, namely, an optical fiber cantilever 122. In some embodiments, the optical fiber 12 is disposed on the lower surface of the actuator 11. The arrangement mode, position, and the like may be referred to and compared with the above content, and will not be elaborated herein.

The actuator 11 is made of a piezoelectric material to achieve piezoelectric actuation. In this example, the actuator 11 is a one-piece piezoelectric sheet. Certainly, in this case, corresponding electrode layers (such as printed circuits) may be disposed on the upper surface and lower surface of the actuator 11. With reference to FIG. 1c, after an electrode layer 114 is electrified, a piezoelectric sheet 115 generates an inverse piezoelectric effect, undergoes deformation, and can vibrate under certain frequency conditions. It should be noted that a dashed-line pattern shown in FIG. 1c represents one possible deformation state of the entire actuator 11. Moreover, in the embodiments of this disclosure, the piezoelectric material may be considered to have undergone a corresponding polarization treatment, and thus can undergo controlled deformation under the action of electrodes.

In some embodiments, with reference to FIG. 1d, the actuator 11 may be of a dual piezoelectric sheet structure (also referred to as a dual-chip structure). Specifically, the actuator 11 includes a substrate 110 and piezoelectric sheets 115a and 115b disposed on upper and lower sides of the substrate 110. A corresponding electrode layer 114 is provided on each of upper and lower surfaces of each piezoelectric sheet. The material for the substrate 110 may not be a piezoelectric material, but may be a material with certain rigidity and toughness, such as epoxy resin or steel. Another case under this mode may be referred to in FIG. 1e. The substrate 110 serves as a common electrode layer. In this case, the electrode layers are disposed on the upper surface of the piezoelectric sheet 115a and the lower surface of the piezoelectric sheet 115b. The electrode layers may interact with the substrate 110, which serves as the common electrode layer, to drive the piezoelectric sheets to vibrate.

In some embodiments, with reference to FIG. 1f, the actuator 11 may be of a multi-layer structure, that is, the actuator 11 is composed of multiple layers of piezoelectric sheets 115a to 115d stacked together, with an electrode layer disposed between every two layers of piezoelectric sheets. Certainly, the specific number of layers will be determined according to practical application requirements. FIG. 1f is only an example. The multi-layer stacked structure enables the deformation of each layer of piezoelectric sheet to be superimposed, thereby achieving a relatively large overall deformation with an extremely low driving voltage. When applied in practice, the stacked structure can obtain a large vibration swing while maintaining low power consumption. Such characteristics are conducive to obtaining a large FOV (Field of View) and reducing power consumption in the display imaging process.

In some other examples, the actuator 11 may be made of a non-piezoelectric material, and is actuated through electromagnetic actuation, thermal actuation, electrostatic actuation, or the like.

When in operation, the actuator 11 mainly vibrates in one direction: the end of the actuator 11 vibrates in the X-axis direction at a set frequency. The frequency of vibration of the actuator 11 is related to a frequency of a driving signal, a natural frequency of the actuator 11, and the like, and will be described in detail in the subsequent content of this disclosure. Under the actuation of the actuator 11, the optical fiber cantilever 122 resonates, thereby achieving amplified vibration at a set amplitude and a set frequency.

In some embodiments, the scanning device 10 may further include a lens, a one-dimensional galvanometer, a package housing, and the like. In addition, the scanning device 10 may operate with other components, such as an RGB laser light source and a driving circuit, to achieve scanning display imaging.

In some embodiments, the scanning device 10 may be used in a lidar device together with a non-visible light laser source, a corresponding driving control circuit, and the like, to achieve ranging and environmental scanning.

In some other embodiments, the scanning device 10 may be used in an endoscope device together with a lighting source, a reflected light sensor, and the like.

In the embodiments of this disclosure, the scanning device may be in different forms.

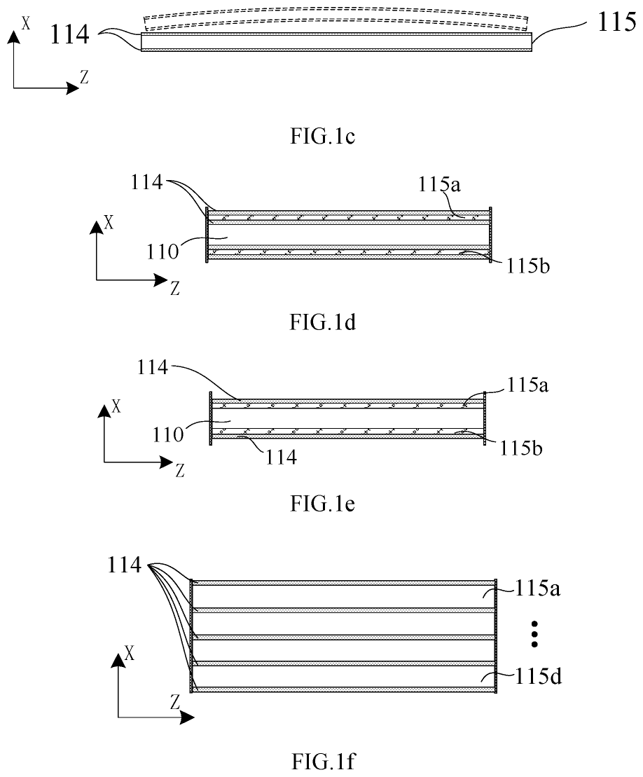

With reference to FIG. 2a, in some feasible implementations, the actuator 21 in the scanning device 20 is provided with the through channel 213 along the length direction, the optical fiber 22 may be disposed in the through channel and fixedly connected to the actuator 21, and the optical fiber 22 extends from a front end of the through channel to form the optical fiber cantilever 222.

In the embodiments of this disclosure, considering that the actuator 21 in operation drives the optical fiber 22 to resonate at a high frequency, to ensure vibration response and amplitude distribution of the optical fiber 22, in one or more embodiments, the through channel of the actuator 21 is usually disposed on the symmetry axis of the actuator 21 along the length direction, namely, the central axis (refer to the central axis MN shown in FIG. 1b). Certainly, in some embodiments, the through channel may be disposed at an asymmetrical axis position. For example, the through channel may be disposed parallel to the central axis MN. The through channel enables the optical fiber 22 to be better fixed and be more stable at boundaries. Certainly, this mode may incur difficulties in fabrication of the actuator 21.

In some embodiments, the front end of the actuator 21 may be narrowed to form a tip. With reference to FIG. 2b, a tip structure is shown. The dimension of the tip of the actuator 21 in the Y-axis direction matches the diameter of the optical fiber 22 (that is, the tip is basically narrowed to the diameter of the optical fiber 22). The end structure makes it easier for the actuator 21 to obtain a larger amplitude when in operation under the same driving conditions (such as the same driving voltage).

For the structural forms shown in FIG. 2a and FIG. 2b, a buffer structure may be further provided at the front end of the actuator 21. With reference to FIG. 2c, a lateral cross-sectional view of an actuator 21 with a buffer structure is shown. The through channel 213 of the actuator 21 forms an open structure 215 at the front end, which is used to reduce a force on a side wall of the optical fiber 22 when the optical fiber 22 swings, thereby protecting the optical fiber. An inner wall of the open structure 215 is smoothly transitioned to minimize the force on the optical fiber 22 to the greatest extent. In this embodiment, if the actuator 21 only achieves one-dimensional vibration, that is, drives the optical fiber 22 to vibrate in the X-axis direction, the buffer structure at the front end of the actuator 21 may be disposed to match the vibration direction of the optical fiber 22.

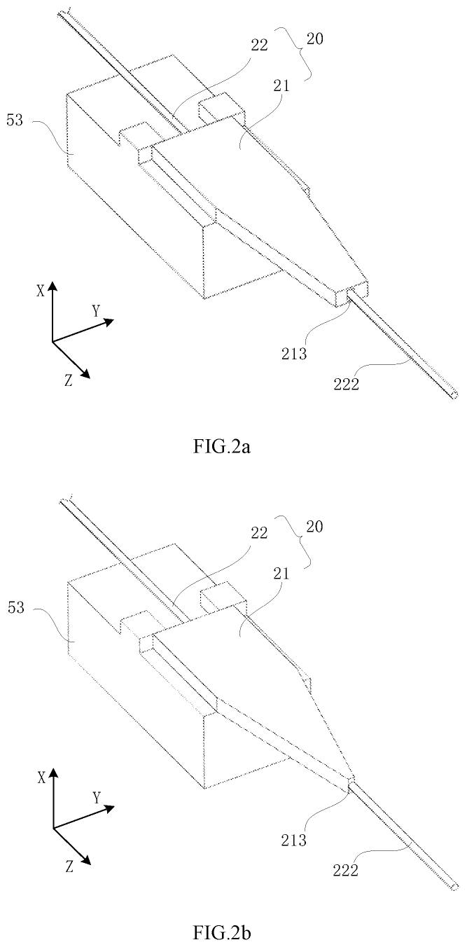

In addition to the above structural forms, in some other embodiments of this disclosure, the optical fiber may not be cantilevered, that is, a light output end face of the optical fiber is flush with a front end face of the actuator. With reference to FIG. 3, a scanning device 30 is shown. The actuator 31 is provided with a through channel, the optical fiber 32 is disposed in the through channel 33, and the light output end face of the optical fiber 32 is flush with the front-end face of the actuator 31. In this form, the optical fiber 32 does not generate amplified vibration, but vibrates in coordination driven by the actuator 31, and maintains consistent frequency or vibration characteristics with the actuator 31. In this example, the overall form of the actuator 31 is the same as that of the actuator 21 shown in FIG. 2b above. The part of the actuator 31 that extends beyond the support base 53 is narrowed to form a tip, which is conducive to obtaining a larger vibration amplitude.

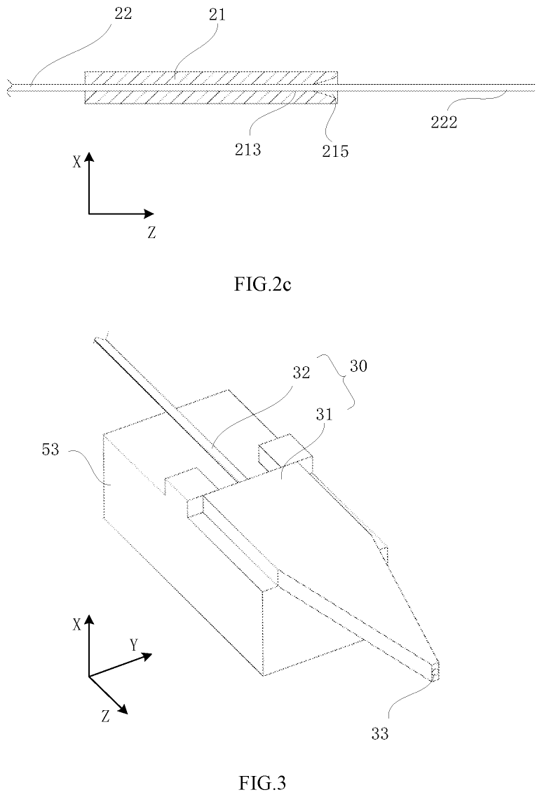

For the scanning devices in the foregoing embodiments, the actuators therein may contain two (or even more) materials, and different materials are used to form different structural parts. Here, the actuator 11 is taken as an example. With reference to FIG. 4, the front end of the actuator 11 (area 11A in FIG. 4) is made of material A, while the other parts are made of piezoelectric material B. The optical fiber 12 is fixed to the actuator 11 by adhesive bonding, with area 11A serving as an adhesive bonding area. This mode, together with factors such as the structure of the actuator 11 and the overall shape of the front end face of the actuator, will jointly influence the frequency characteristics of the optical fiber 12 after bonding. Moreover, this mode is also more conducive to calibration of an adhesive bonding position of the optical fiber during the fabrication of the scanning device, and facilitates the application and curing of an adhesive. The material A may be a resin material or other materials with the same functionality. Certainly, it may be understood that FIG. 4 is only an example. In practical application, the part of the front end of the actuator 11 close to the end face may all be made of material A, not limited to the area 11A shown in FIG. 4.

In the embodiments of this disclosure, the structural form of the support base 53 may be set according to practical application needs and is not restricted in this disclosure. The structural form of the support base 53 shown in the above drawings is only an example and should not be understood as a limitation of this disclosure.

Certainly, the wedge-shaped sheet structure of the actuator is only a feasible approach. Besides the structural forms shown in the foregoing embodiments, in other embodiments, the actuator is gradually narrowed in the X-axis direction (namely, the thickness direction), but is not narrowed in the width direction. Alternatively, the end of the actuator is narrowed in both the thickness direction and the width direction.

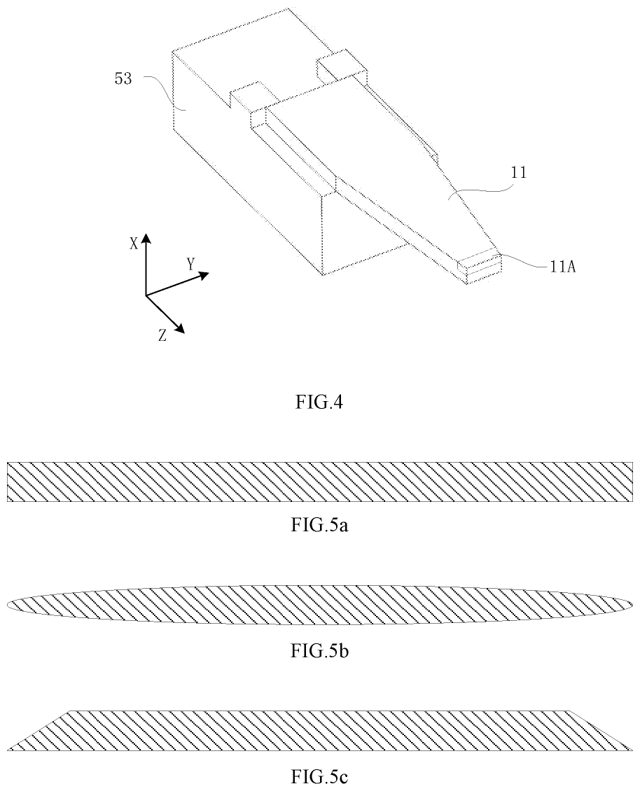

In addition, the structure of the actuator may be in other forms. For example, with reference to FIG. 5a, FIG. 5b, and FIG. 5c, several optional implementations of the scanning device are shown. As shown in FIG. 5a, the entire cross-section of the actuator in the direction perpendicular to the width in the previous several embodiments may be a rectangular cross-section, to form the sheet structure in the previous embodiments. In FIG. 5b, the overall shape of the actuator may still be sheet-like, but the cross-section perpendicular to the width direction may be elliptical. In this case, the thickness of the actuator is not exactly the same, but has a smooth transition. In the implementation shown in FIG. 5c, the cross-section perpendicular to the width direction may be isosceles trapezoidal, to form another sheet-like actuator.

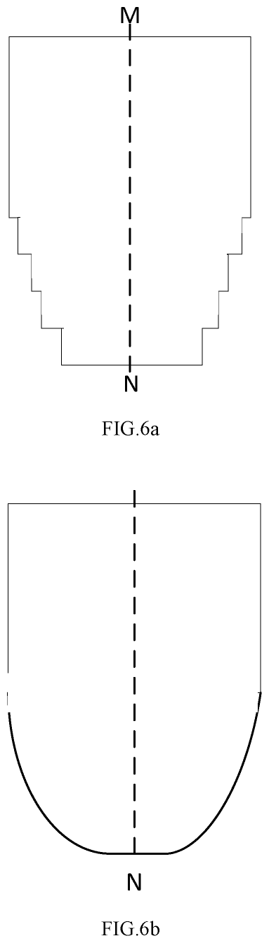

The free end of the actuator may be contracted in a mode shown in FIG. 1b to form the front end, but may be narrowed in other forms, such as in a progressive or smooth mode shown in FIG. 6a or FIG. 6b to form the front end. Similar to the implementation shown in FIG. 1b, the optical fiber extends from the back end of the actuator to the front end, and the axis of the light output end of the optical fiber is parallel to the central axis of the actuator along the length direction. In one or more embodiments, the plane which is perpendicular to the width direction and in which the axis of the light output end of the optical fiber is located is coplanar with the plane which is perpendicular to the width direction and in which the central axis of the actuator along the length direction is located.

In some embodiments of this disclosure, the optical fiber may be provided with a specific end structure at the light output end. The end structure may include a conical structure in which the diameter of the optical fiber is gradually narrowed, a spherical structure formed at the end, a recessed structure formed at the light output position of the end, or the like. Different end structures may achieve different optical effects on light output from the optical fiber, such as changing the optical fiber natural frequency, improving the uniformity of light spots, and controlling a divergence angle. The corresponding end structure is specifically determined according to actual application needs, and is not specifically limited herein.

In the embodiments of this disclosure, the actuator may have a natural frequency based on one or more attributes. Generally, a natural frequency is an intrinsic frequency characteristic of a device. In some examples, the natural frequency and a resonance frequency (or resonant frequency) are equivalent. The one or more attributes include but are not limited to: a material, a Young's modulus, a second axial moment of area, a density, a sectional area, a length, and/or a mode constant. It should also be noted that the natural frequency of the actuator in this disclosure does not just have one frequency point, but has a series of frequency points distributed according to a specific law, that is, has a plurality of orders (Order).

The optical fiber may also have a natural frequency based on one or more attributes, and the one or more attributes may include but are not limited to: an optical fiber cantilever length, a fiber cross-sectional shape, a fiber cross-sectional dimension, and a material. Similarly, the natural frequency of the optical fiber also has a plurality of orders. Certainly, the natural frequency of the optical fiber mainly refers to a natural frequency of the optical fiber cantilever.

When the actuator and the optical fiber are in a vibration state, a corresponding vibration mode is generated. In the embodiments of this disclosure, a bending mode is mainly considered. Usually, an amplitude may be controlled by using first-order bending modes of the actuator and the optical fiber. After the optical fiber is fastened on the actuator, the vibration modes of the two influence each other and couple with each other, to form a new vibration mode.

However, the inventor of this disclosure found that for the actuator, bending deformation directions of its first-order and second-order bending modes are orthogonal to each other; and for the optical fiber with a circular cross-section, bending deformation directions of its first-order and second-order bending modes do not coincide, while frequency intervals of its first-order and second-order bending modes are relatively close (tens to hundreds of Hz). The bending mode with the bending deformation direction parallel to the X-axis direction is advantageous. However, since the first-order and second-order bending mode frequencies of the optical fiber are relatively close, the optical fiber is prone to a vibration component in the Y-axis direction. The actuator may also experience a vibration component in the Y-axis direction. This will cause a scanning trajectory of the fiber scanner to no longer be a straight line, but to present a nonlinear scanning trajectory, such as an elliptical trajectory, an arc-shaped trajectory, or a trajectory similar to the number “8”. These nonlinear scanning trajectories will cause serious interference to actual imaging effects.

Therefore, reasonable frequency characteristics may be configured during the design and fabricating process, to increase intervals between the first-order and second-order bending mode frequencies of the optical fiber and the first-order and second-order bending mode frequencies of the actuator as much as possible, so that the fiber scanner can achieve a good scanning display effect.

In the embodiments of this disclosure: Fp1 is a first-order bending mode natural frequency of the actuator, with a bending direction defined as the X direction; Fp2 is a second-order bending mode natural frequency of the actuator, with a bending direction orthogonal to the first-order bending direction; Ff1 is a first-order bending mode natural frequency of the optical fiber cantilever; Fx1 is a first-order bending mode resonance frequency of the optical fiber cantilever along the X-axis direction after the optical fiber is assembled with the actuator; Fxh is a second-order bending mode resonance frequency of the optical fiber cantilever along the X-axis direction after the optical fiber is assembled with the actuator; Fy is a first-order bending mode resonance frequency of the optical fiber cantilever along the Y-axis direction after the optical fiber is assembled with the actuator.

The scanning device provided by the implementations shown earlier in this disclosure, through the structural design of the actuator and the optical fiber, has the following frequency characteristics: the second-order bending mode natural frequency Fp2 of the actuator in the first direction and the first-order bending mode natural frequency Fp1 of the actuator in the first direction satisfy a set condition: Fp2>2Fp1.

After the optical fiber is fixed to the actuator, a ratio of the first-order bending mode resonance frequency Fx1 of the optical fiber cantilever in the first direction to the bending mode natural frequency Fp1 of the actuator in the first direction is within a first numerical range;

An interval between the first-order bending mode natural frequency Ff1 of the optical fiber and the first-order bending mode natural frequency Fp1 of the actuator is within a second numerical range.

This ensures that a frequency interval between the first-order bending mode resonance frequency Fx1 of the optical fiber in the first direction and the first-order bending mode resonance frequency Fy of the optical fiber in the second direction is not less than a set value.

The following provides a more detailed description of frequency characteristics of the scanning device provided in the embodiments of this disclosure in combination with test data in Table 1 and the drawings.

TABLE 1

| Optical | | | | Optical | | | | | |
|---|---|---|---|---|---|---|---|---|---|
| fiber | | | | fiber | | | | Δdf = | Δdpf = |
| cantilever | | | | driving | | | | Fy − | Fp1 − |
| length | | | | frequency/ | | | | Fx1 | Ff1 |
| (mm) | Fp1/KHz | Fp2/KHz | Ff1/KHz | KHz | Fx1/KHz | Fxh/KHz | Fy/KHz | (KHz) | (KHz) |
| 3600 | 24.47 | 57.47 | 16.38 | 15.6 | 15.6 | 24.51 | 16.31 | 0.71 | 8.09 |
| 3500 | 24.47 | 57.47 | 17.05 | 16.63 | 16.63 | 25.88 | 17.27 | 0.64 | 7.42 |
| 3400 | 24.47 | 57.47 | 18.45 | 17.87 | 17.87 | 25.89 | 18.58 | 0.71 | 6.02 |
| 3300 | 24.47 | 57.47 | 19.09 | 18.86 | 18.86 | 26.1 | 19.76 | 0.9 | 5.38 |
| 3200 | 24.47 | 57.47 | 20.76 | 19.46 | 19.46 | 24.8 | 20.43 | 0.97 | 3.71 |
| 3100 | 24.47 | 57.47 | 21.08 | 20.5 | 20.5 | 24.9 | 22.02 | 1.52 | 3.39 |
| 3000 | 24.47 | 57.47 | 22.37 | 21.47 | 21.47 | 25.2 | 22.76 | 1.29 | 2.1 |
| 2900 | 24.47 | 57.47 | 22.99 | 22.5 | 22.5 | 26.26 | 24.08 | 1.58 | 1.48 |
| 2800 | 24.47 | 57.47 | 24.1 | 23.14 | 23.14 | 26.77 | 24.84 | 1.7 | 0.37 |
| 2700 | 24.47 | 57.47 | 24.96 | 23.82 | 23.82 | 27.12 | 25.79 | 1.97 | −0.49 |
| 2600 | 24.47 | 57.47 | 26.05 | 27.57 | 24.46 | 27.57 | 26.32 | 1.25 | −1.58 |
| 2500 | 24.47 | 57.47 | 26.81 | 28.07 | 24.66 | 28.07 | 27.4 | 0.67 | −2.34 |
| 2400 | 24.47 | 57.47 | 27.7 | 28.47 | 24.64 | 28.47 | 28.06 | 0.41 | −3.23 |
| 2300 | 24.47 | 57.47 | 28.4 | 29.52 | 24.08 | 29.52 | 29.16 | 0.36 | −3.93 |
| 2200 | 24.47 | 57.47 | 29.83 | 30.39 | 25 | 30.39 | 30.2 | 0.19 | −5.36 |

In Table 1, different lengths of optical fiber cantilevers are taken as data for testing, and the actuator may be a piezoelectric actuator made of a piezoelectric material. The optical fiber cantilever length is an important factor affecting the optical fiber natural frequency. In the test, the optical fiber cantilever length was gradually decreased from 3600 mm to 2200 mm.

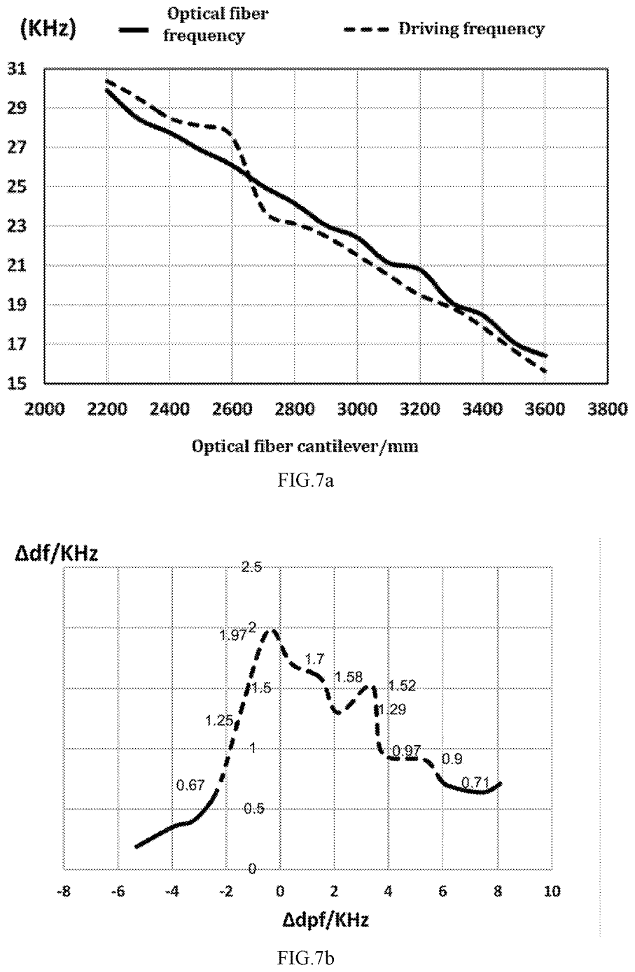

With reference to FIG. 7a, after the optical fiber is bonded to the actuator, the longer the optical fiber cantilever, the lower the required driving frequency. The optical fiber natural frequency is generally proportional to the driving frequency.

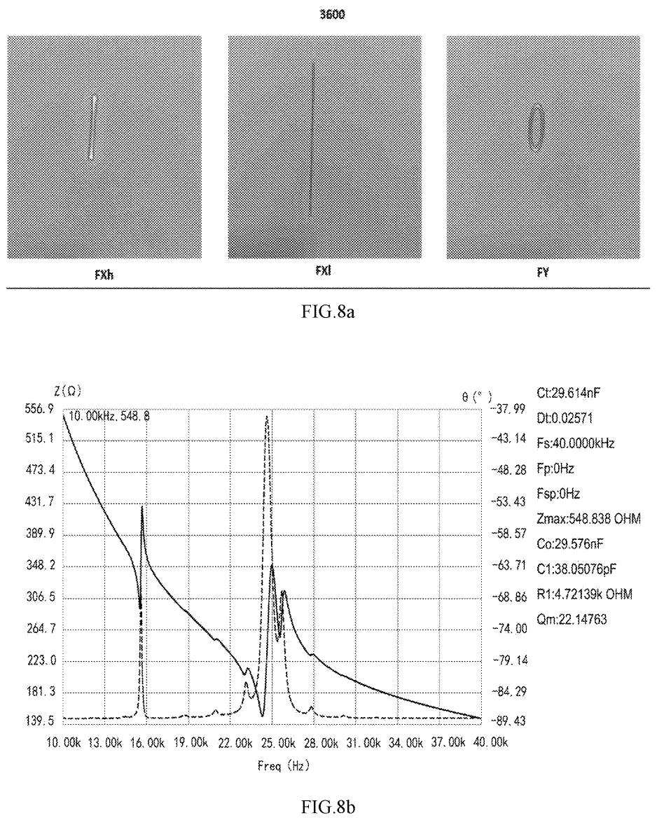

FIG. 8a to FIG. 22b respectively show scanning trajectory diagrams of an optical fiber operating at three frequencies Fx1, Fxh, and Fy under each optical fiber cantilever length in table 1 and impedance curve diagrams (the impedance curve diagrams can represent response characteristics or filtering characteristics of an actuator and an optical fiber to the driving frequencies). It can be seen from the combination of each trajectory diagram and the data shown in Table 1 that the closer the optical fiber natural frequency to the first-order bending mode frequency of the actuator, the smaller a tilt angle of an image swing trajectory, and the farther the scanning driving frequency from an opening frequency point. The opening frequency indicates that when the optical fiber vibrates at a certain frequency, in addition to vibrating in the first direction, the vibration component in the second direction tends to be obvious, resulting in an elliptical opening in the optical fiber scanning trajectory. In this example, Fy may be regarded as an opening frequency point.

For example, in the trajectory diagram shown in FIG. 8a, the optical fiber cantilever length is 3600 mm. In this case, the scanning trajectory diagram of the optical fiber in the second direction shows that the vibration component of the optical fiber in the second direction is relatively small, and the vibration component begins to affect the first-order and second-order scanning trajectories of the optical fiber in the first direction, with a swing trajectory slightly tilted. In this case, Δdf=Fy−Fx1=0.71 KHZ, where Δdf represents an interval between the first-order bending mode resonance frequencies of the optical fiber in the first direction and the second direction after the optical fiber is fixed to the actuator. Δdpf=Fp1−Ff1 is 8.09 KHZ. Δdpf is a difference between the optical fiber natural frequency and the actuator natural frequency, namely, an interval between the optical fiber natural frequency Ff1 and the first-order bending mode natural frequency Fp1 of the actuator. FIG. 8b shows an impedance curve diagram.

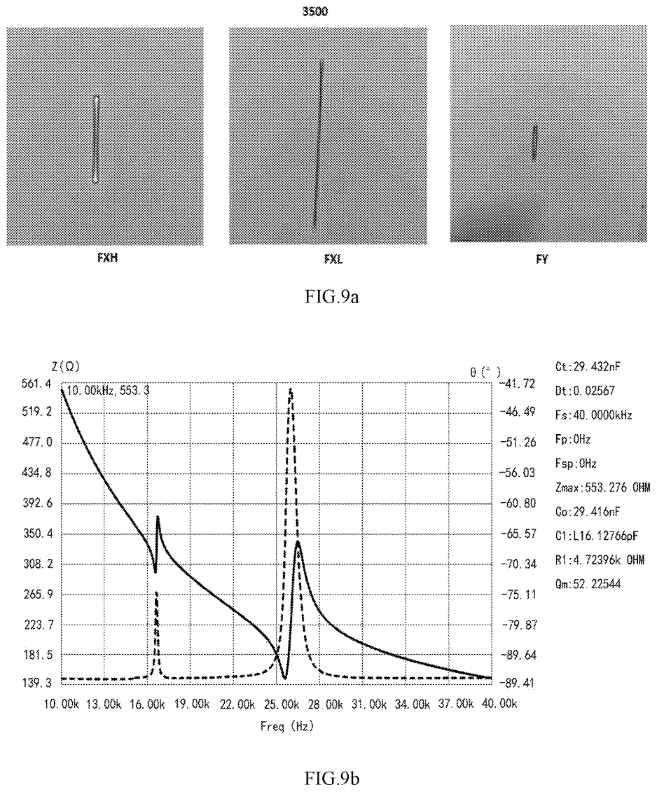

For example, in the trajectory diagram shown in FIG. 9a, the optical fiber cantilever length is 3500 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction tends to become obvious, with a swing trajectory slightly tilted. In this case, Δdf=Fy−Fx1=0.64 KHZ, where Δdf represents an interval between the first-order bending mode resonance frequencies of the optical fiber in the first direction and the second direction after the optical fiber is fixed to the actuator. Δdpf=Fp1−Ff1 is 7.42 KHZ. Δdpf is a difference between the optical fiber natural frequency and the actuator natural frequency, namely, an interval between the optical fiber natural frequency Ff1 and the first-order bending mode natural frequency Fp1 of the actuator. FIG. 9b shows an impedance curve diagram.

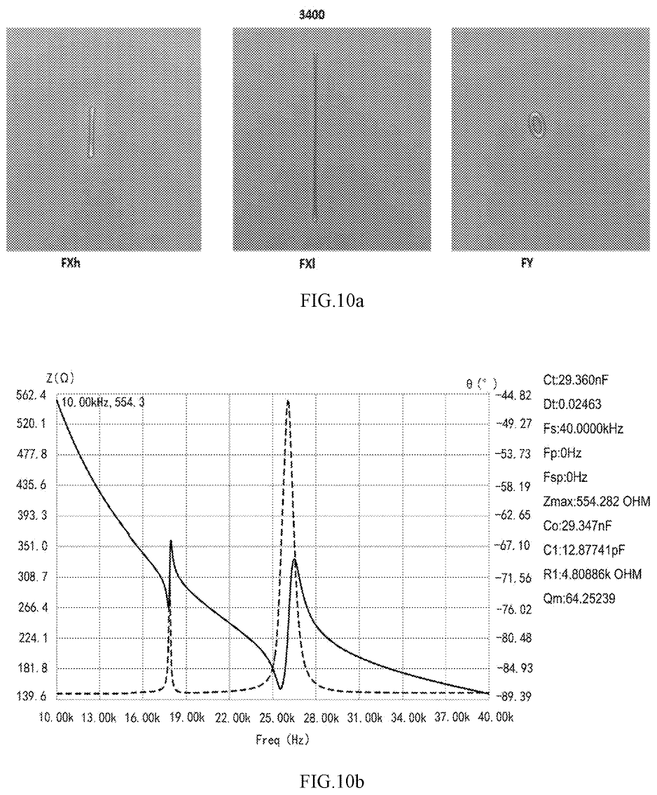

For example, in the trajectory diagram shown in FIG. 10a, the optical fiber cantilever length is 3400 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is non-obvious, with a swing trajectory slightly tilted. In this case, Δdf=Fy−Fx1=0.71 KHZ, where Δdf represents an interval between the first-order bending mode resonance frequencies of the optical fiber in the first direction and the second direction after the optical fiber is fixed to the actuator. Δdpf=Fp1−Ff1 is 6.02 KHZ. Δdpf is a difference between the optical fiber natural frequency and the actuator natural frequency, namely, an interval between the optical fiber natural frequency Ff1 and the first-order bending mode natural frequency Fp1 of the actuator. FIG. 10b shows an impedance curve diagram.

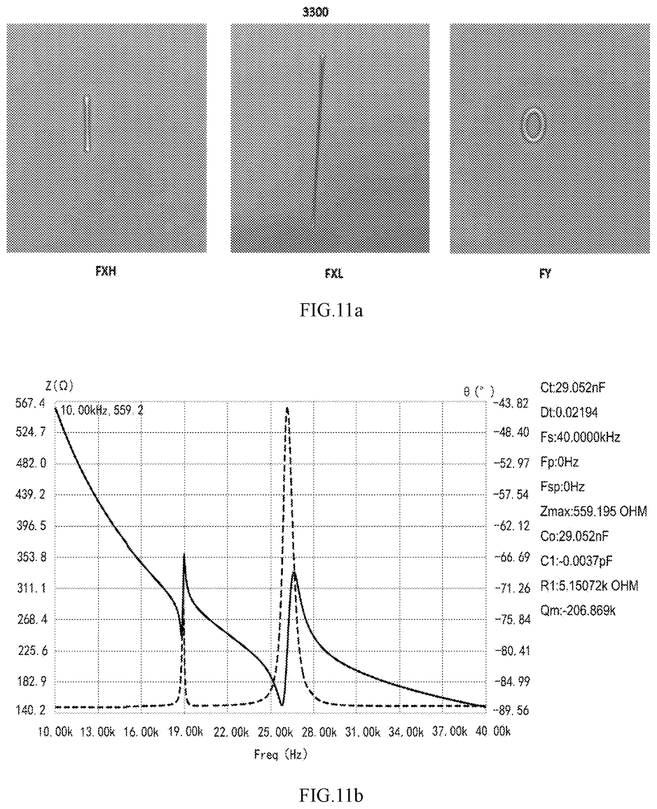

For example, in the trajectory diagram shown in FIG. 11a, the optical fiber cantilever length is 3300 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is obvious, with a swing trajectory slightly tilted. In this case, Δdf=Fy−Fx1=0.9 KHz, where Δdf represents an interval between the first-order bending mode resonance frequencies of the optical fiber in the first direction and the second direction after the optical fiber is fixed to the actuator. Δdpf=Fp1−Ff1 is 5.38 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 11b shows an impedance curve diagram.

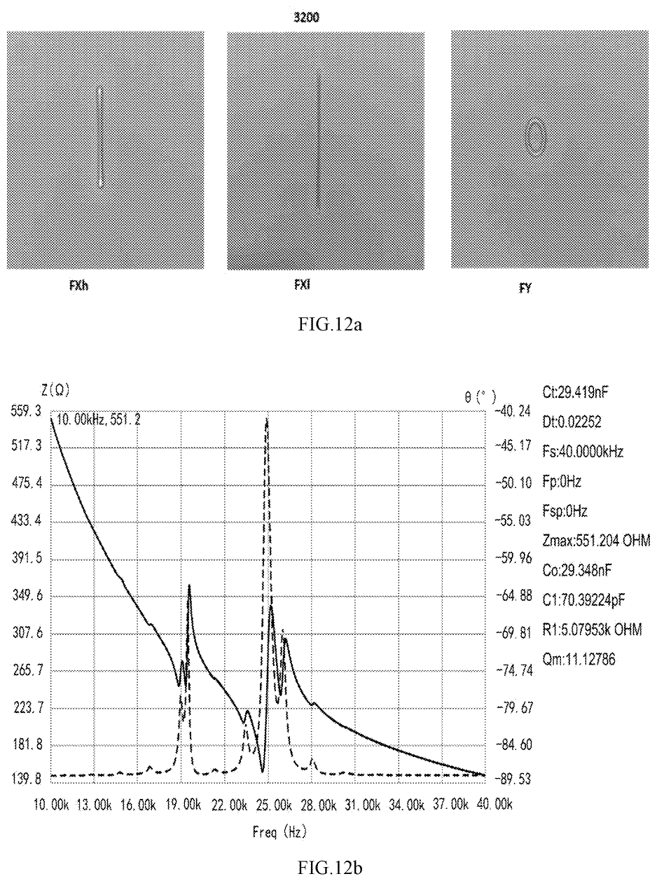

For example, in the trajectory diagram shown in FIG. 12a, the optical fiber cantilever length is 3200 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is non-obvious, with a swing trajectory almost not tilted. In this case, Δdf=Fy−Fx1=0.97 KHz, where Δdf represents an interval between the first-order bending mode resonance frequencies of the optical fiber in the first direction and the second direction after the optical fiber is fixed to the actuator. Δdpf=Fp1−Ff1 is 3.71 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 12b shows an impedance curve diagram.

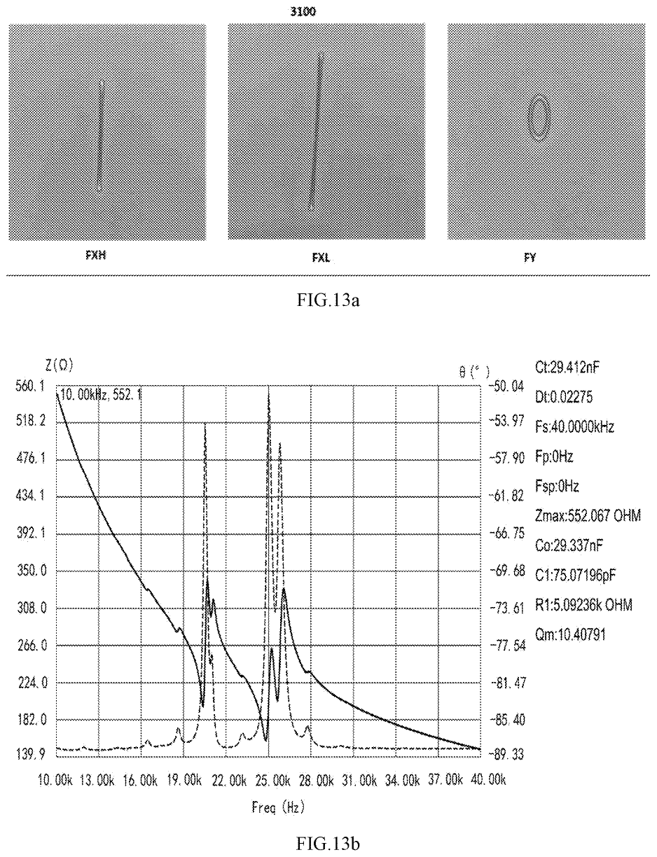

For example, in the trajectory diagram shown in FIG. 13a, the optical fiber cantilever length is 3100 mm. In this case, the scanning trajectory diagram of the optical fiber in the second direction shows that the vibration component of the optical fiber in the second direction is relatively large, and the influence of the vibration component on the first-order and second-order scanning trajectories of the optical fiber in the first direction is obvious, with a swing trajectory obviously tilted. In this case, Δdf=Fy−Fx1=1.52 KHz, where Δdf represents an interval between the first-order bending mode resonance frequencies of the optical fiber in the first direction and the second direction after the optical fiber is fixed to the actuator. Δdpf=Fp1−Ff1 is 3.39 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 13b shows an impedance curve diagram.

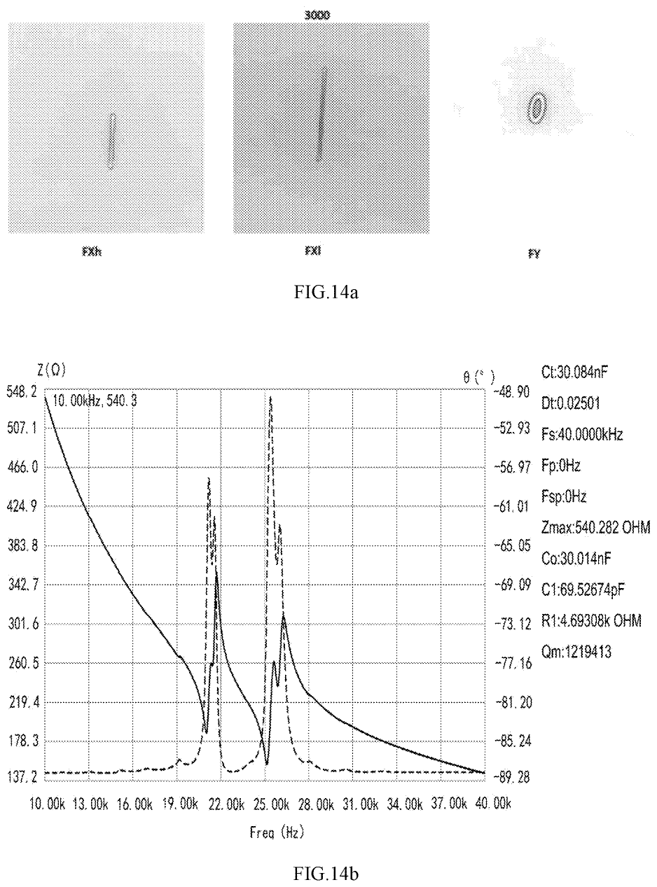

For example, in the trajectory diagram shown in FIG. 14a, the optical fiber cantilever length is 3000 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is non-obvious, with a swing trajectory not obviously tilted. In this case, Δdf=Fy−Fx1=1.29 KHz, where Δdf represents an interval between the first-order bending mode resonance frequencies of the optical fiber in the first direction and the second direction after the optical fiber is fixed to the actuator. Δdpf=Fp1−Ff1 is 2.1 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 14b shows an impedance curve diagram.

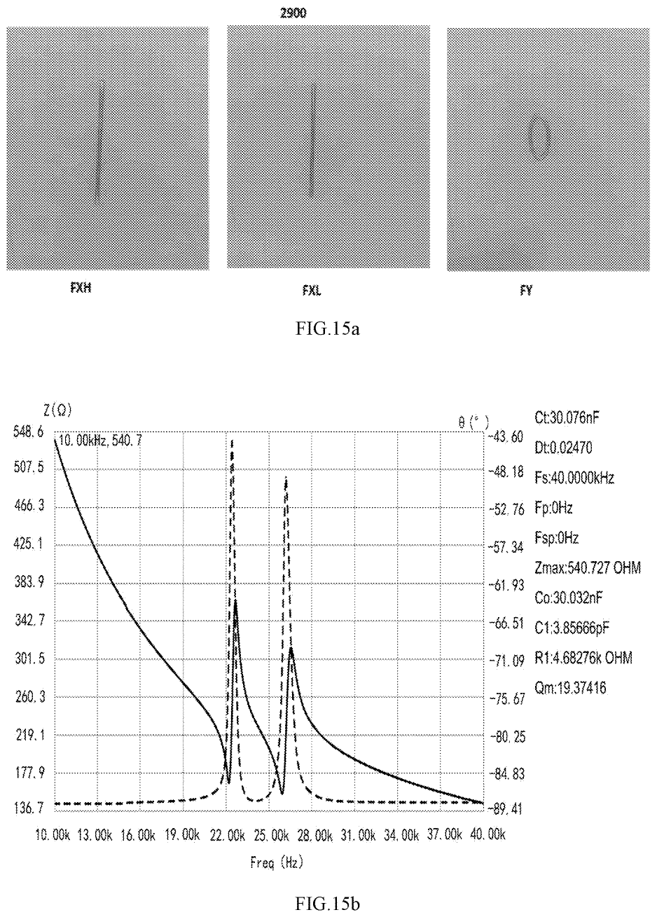

For example, in the trajectory diagram shown in FIG. 15a, the optical fiber cantilever length is 2900 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is non-obvious, with a swing trajectory not obviously tilted. In this case, Δdf=Fy−Fx1=1.58 KHz, where Δdf represents an interval between the first-order bending mode resonance frequencies of the optical fiber in the first direction and the second direction after the optical fiber is fixed to the actuator. Δdpf=Fp1−Ff1 is 1.48 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 15b shows an impedance curve diagram.

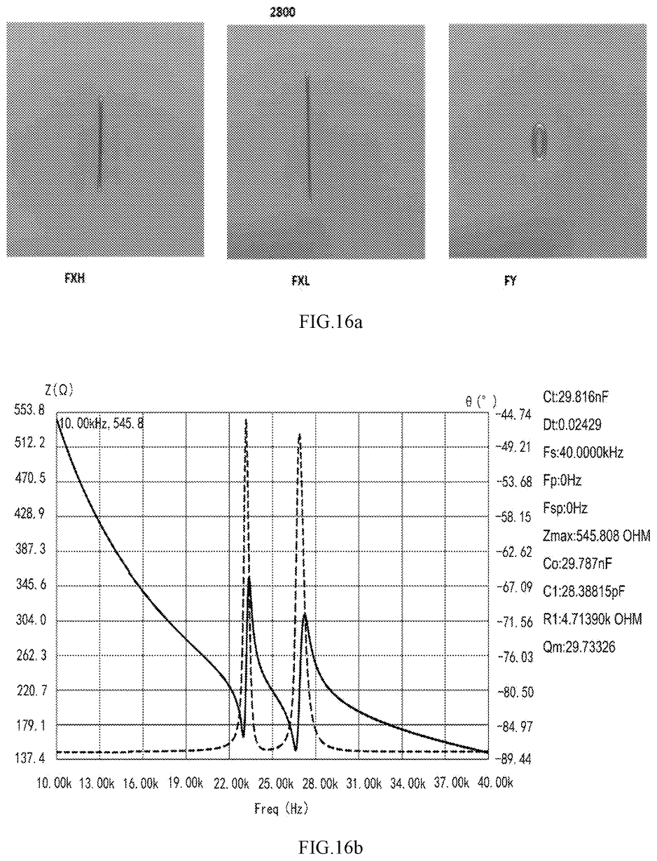

For example, in the trajectory diagram shown in FIG. 16a, the optical fiber cantilever length is 2800 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is non-obvious, with a swing trajectory not obviously tilted. In this case, Δdf=Fy−Fx1=1.7 KHz, where Δdf represents an interval between the first-order bending mode resonance frequencies of the optical fiber in the first direction and the second direction after the optical fiber is fixed to the actuator. Δdpf=Fp1−Ff1 is 0.37 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 16b shows an impedance curve diagram.

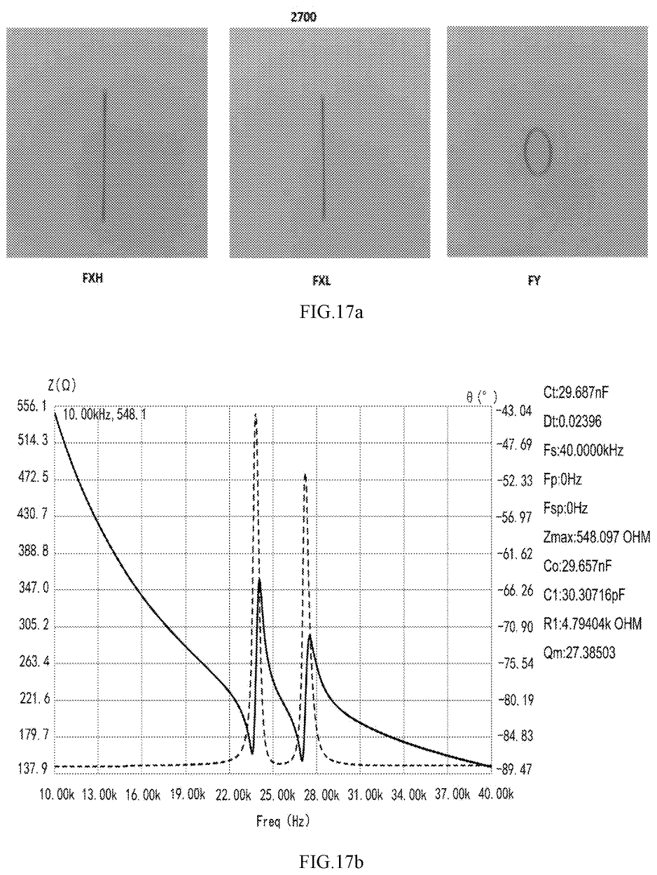

For example, in the trajectory diagram shown in FIG. 17a, the optical fiber cantilever length is 2700 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is non-obvious, with a swing trajectory not obviously tilted. In this case, Δdf=Fy−Fx1=1.97 KHz, where Δdf represents an interval between the first-order bending mode resonance frequencies of the optical fiber in the first direction and the second direction after the optical fiber is fixed to the actuator. Δdpf=Fp1−Ff1 is −0.49 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 17b shows an impedance curve diagram.

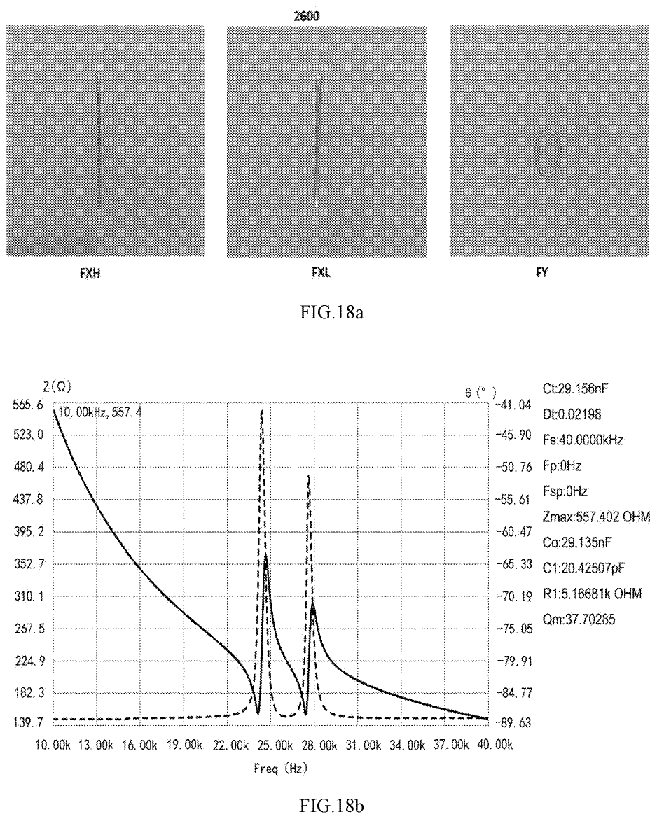

For example, in the trajectory diagram shown in FIG. 18a, the optical fiber cantilever length is 2600 mm. In this case, the scanning trajectory diagram of the optical fiber in the second direction shows that the vibration component of the optical fiber in the second direction is relatively small, and the influence of the vibration component on the first-order and second-order scanning trajectories of the optical fiber in the first direction is non-obvious, with a swing trajectory not obviously tilted. In this case, Δdf=Fy−Fx1=1.25 KHz, where Δdf represents an interval between the first-order bending mode resonance frequencies of the optical fiber in the first direction and the second direction after the optical fiber is fixed to the actuator. Δdpf=Fp1−Ff1 is −1.58 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 18b shows an impedance curve diagram.

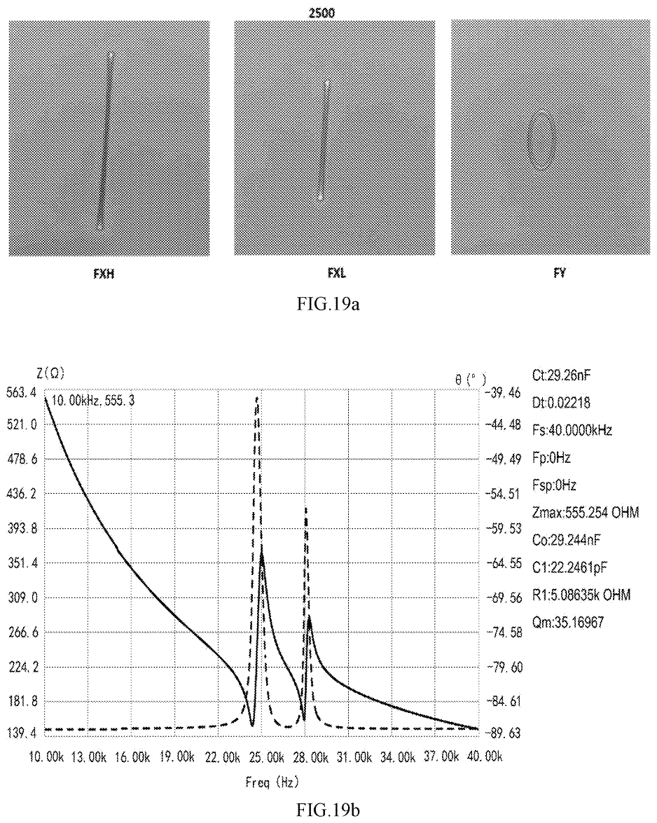

For example, in the trajectory diagram shown in FIG. 19a, the optical fiber cantilever length is 2500 mm. In this case, the scanning trajectory diagram of the optical fiber in the second direction shows that the vibration component of the optical fiber in the second direction is relatively large, and the influence of the vibration component on the first-order and second-order scanning trajectories of the optical fiber in the first direction is obvious, with a swing trajectory obviously tilted. In this case, Δdf=Fy−Fx1=0.67 KHz, where Δdf represents an interval between the first-order bending mode resonance frequencies of the optical fiber in the first direction and the second direction after the optical fiber is fixed to the actuator. Δdpf=Fp1−Ff1 is −2.34 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 19b shows an impedance curve diagram.

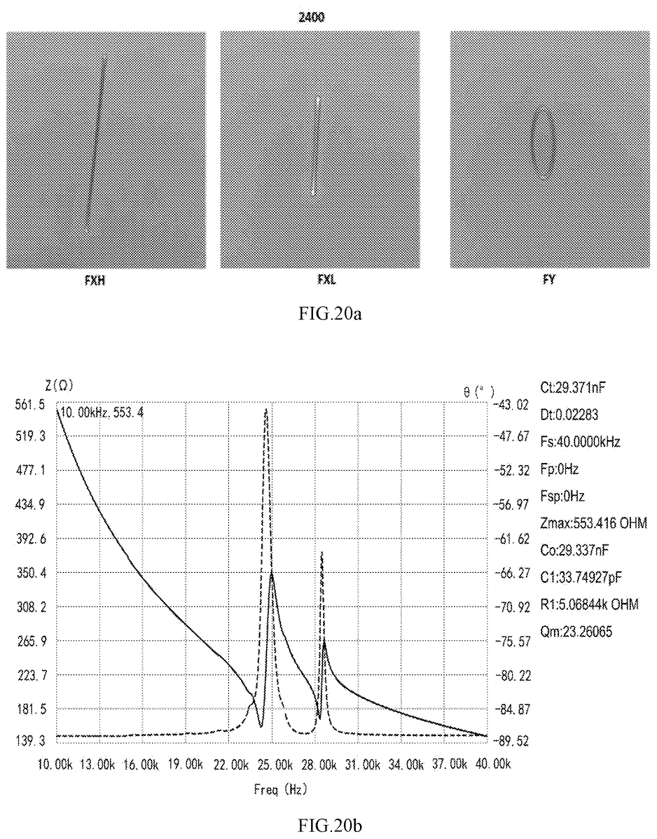

For example, in the trajectory diagram shown in FIG. 20a, the optical fiber cantilever length is 2400 mm. In this case, the scanning trajectory diagram of the optical fiber in the second direction shows that the vibration component of the optical fiber in the second direction is relatively large, and the influence of the vibration component on the first-order and second-order scanning trajectories of the optical fiber in the first direction is obvious, with a swing trajectory obviously tilted. In this case, Δdf=Fy−Fx1=0.41 KHz, where Δdf represents an interval between the first-order bending mode resonance frequencies of the optical fiber in the first direction and the second direction after the optical fiber is fixed to the actuator. Δdpf=Fp1−Ff1 is −3.23 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 20b shows an impedance curve diagram.

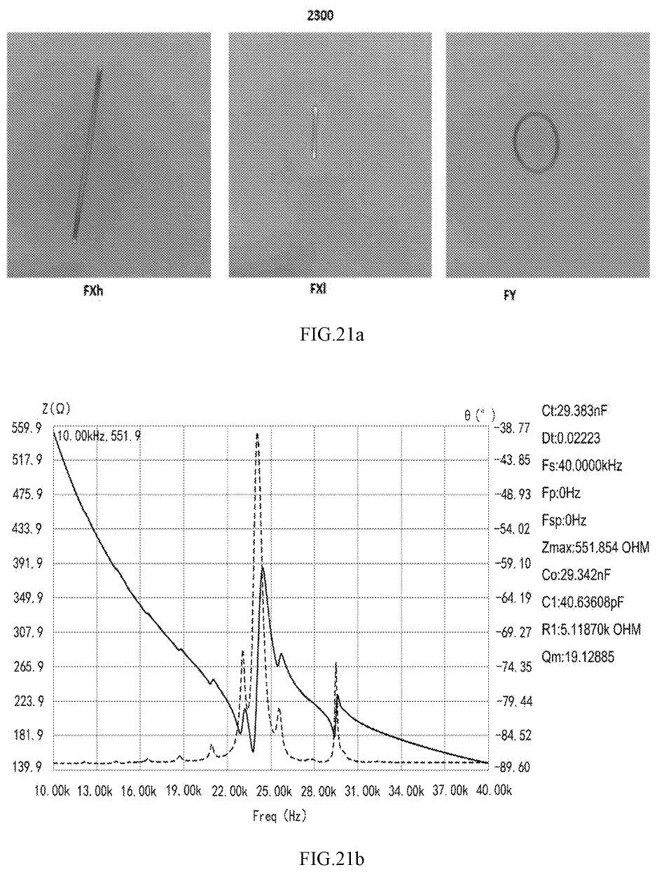

For example, in the trajectory diagram shown in FIG. 21a, the optical fiber cantilever length is 2300 mm. In this case, the scanning trajectory diagram of the optical fiber in the second direction shows that the vibration component of the optical fiber in the second direction is relatively large, and the influence of the vibration component on the first-order and second-order scanning trajectories of the optical fiber in the first direction is obvious, with a swing trajectory obviously tilted. In addition, the scanning trajectory in the first direction appears as a nonlinear scanning trajectory. That is, an opening appears. Then, the first-order bending mode resonance frequency of the optical fiber is an opening frequency. The optical fiber driving frequency in this state is the second-order bending mode resonance frequency in the X direction after the optical fiber is assembled. Due to the appearance of the opening, the optical fiber driving frequency should not be set to this value. In this case, Δdf=Fy−Fx1=0.36 KHz, where Δdf represents an interval between the first-order bending mode resonance frequencies of the optical fiber in the first direction and the second direction after the optical fiber is fixed to the actuator. Δdpf=Fp1−Ff1 is −3.93 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 21b shows an impedance curve diagram.

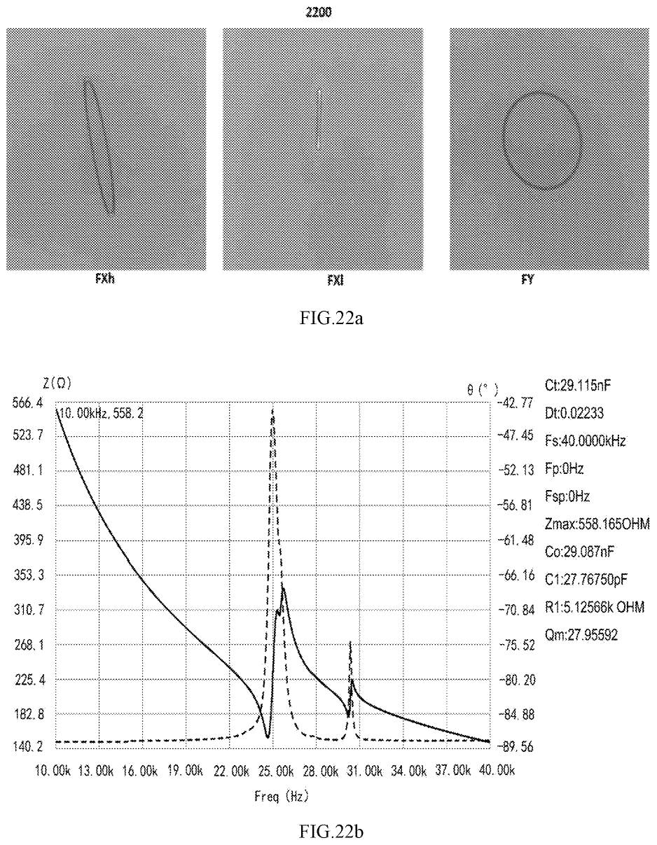

For example, in the trajectory diagram shown in FIG. 22a, the optical fiber cantilever length is 2200 mm. In this case, the scanning trajectory diagram of the optical fiber in the second direction shows that the vibration component of the optical fiber in the second direction is relatively large, and the influence of the vibration component on the first-order and second-order scanning trajectories of the optical fiber in the first direction is obvious, with a swing trajectory obviously tilted. In addition, the scanning trajectory in the first direction appears as a nonlinear scanning trajectory. That is, an opening also appears. Then, the first-order bending mode resonance frequency of the optical fiber is an opening frequency. The optical fiber driving frequency in this state is the second-order bending mode resonance frequency in the X direction after the optical fiber is assembled. Due to the appearance of the opening, the optical fiber driving frequency should not be set to this value. In this case, Δdf=Fy−Fx1=0.19 KHz, where Δdf represents an interval between the first-order bending mode resonance frequencies of the optical fiber in the first direction and the second direction after the optical fiber is fixed to the actuator. Δdpf=Fp1−Ff1 is −5.36 KHz. Δdpf is a difference between the optical fiber natural frequency and the actuator natural frequency, namely, an interval between the optical fiber natural frequency Ff1 and the first-order bending mode natural frequency Fp1 of the actuator. FIG. 22b shows an impedance curve diagram.

From the above trajectory diagrams and the data in Table 1, it can be seen that when the value of Δdf is around 0.7, the swing trajectory is tilted, and when the difference is less than 0.4 KHz, as shown in FIG. 21a and FIG. 22a, an opening appears in the image trajectory. In addition, the trajectory diagrams shown in this disclosure represent instantaneous states. Although the scanning trajectories at some frequencies, such as those at frequency Fx1 in FIG. 8a and FIG. 10a, appear acceptable, their stability is poor. After scanning for a certain duration, undesired trajectory states occur, for example, the trajectory suddenly becomes thicker and then returns to the illustrated state, exhibiting a reciprocating pattern of trajectory variation. With reference to the impedance curve diagrams, FIG. 7b and Table 1, it can be further seen that when the frequency characteristic is satisfied, that is, when the first-order bending mode natural frequency Fp1 of the actuator and the difference between the optical fiber natural frequency and the actuator natural frequency (i.e., Δdpf) are within 2.0 Khz, both the impedance curve (shown with the solider curve) and the phase curve (shown with the broken curve) in the corresponding impedance diagram such as the diagrams shown in FIGS. 8b and 22b of the scanner appear “cleaner”, that is, the curves are smooth overall, with two impedance peaks and two phase peaks. The peaks on the impedance curve and the phase curve correspond to each other and are close in frequency, and the phase peaks are usually higher than the impedance peaks in terms of a trace profile. In this case, the scanner has a stable vibration state and an optimal imaging effect.

In summary, in the implementations of this disclosure, in combination with the state of the scanning trajectory and the state of the impedance curve diagram, the interval between the natural frequency of the optical fiber and the first-order bending mode natural frequency of the actuator may be within the second numerical range of 2 KHz. After the optical fiber is fixed to the actuator, the ratio of the resonance frequency of the optical fiber in the first direction (X direction) to the bending mode frequency of the actuator in the first direction is within the first numerical range, which is 0.9 to 0.98.

Taking Table 1 as an example, when the resonance frequency Fx1 of the optical fiber in the first direction is 0.9 to 0.98 times 24.47, a better scanning effect can be achieved, so the value of Fx1 is 22.02 to 23.98.

In practical application, the bending deformation in the bending deformation direction (the second direction in this disclosure) corresponding to the second-order bending mode natural frequency of the actuator is adverse to the scanning device in the embodiments of this disclosure. By configuring the above frequency characteristics, the interval between the first-order and second-order bending mode natural frequencies of the actuator can be increased. When the driving frequency is applied to the scanning device, the second-order bending mode natural frequency of the actuator is excited to a relatively weak or even difficult extent, thereby minimizing the adverse effect on the scanning device as much as possible.

Furthermore, by configuring the above frequency characteristics, for the scanning device in the embodiments of this disclosure, the first-order bending mode resonance frequency of the optical fiber is basically less than the first-order bending mode natural frequency of the actuator, which further makes the first-order bending mode resonance frequency of the optical fiber far away from the second-order bending mode natural frequency of the actuator. When the driving frequency is applied to the scanning device, the adverse effect on the optical fiber due to the degree of excitation of the second-order bending mode natural frequency of the actuator can be reduced as much as possible.

In addition, an embodiment of this disclosure further provides a scanning display module, which includes at least the scanning device described in the previous embodiments, a light source, and a control circuit.

Under the control of the control circuit, the light source outputs image light, and then the scanning device outputs the image light to implement scanning display.

The expressions “first”, “second”, “the first”, or “the second” used in the embodiments of this disclosure may modify various components regardless of sequence and/or importance, but these expressions do not limit corresponding components. The foregoing expressions are only configured to distinguish components from other components.

The foregoing descriptions are only embodiments of this disclosure and descriptions of applied technical principles. A person skilled in the art should understand that the scope of this disclosure is not limited to a technical solution formed by a specific combination of the foregoing technical features, but also covers other technical solutions formed by any combination of the foregoing technical features or equivalent features without departing from the foregoing inventive concept, for example, a technical solution formed through replacement of the foregoing technical features disclosed in this disclosure with technical features that have similar functions as the foregoing technical features.

1. A scanning device, comprising:
a support base;
an actuator comprising a back end and a front end, wherein the back end is fixedly supported on the support base, and the front end is a free end, the actuator extends along a length direction towards a direction away from the back end, and a dimension of the actuator dimension of the actuator gradually decreases in at least one of a width direction and a thickness direction to form the front end; and
an optical fiber fixed to the actuator, wherein a light output end of the optical fiber is disposed near the front end of the actuator, and is configured to emit light beams forward along the length direction; and
the actuator is configured to drive the optical fiber to vibrate in a first direction in response to a driving signal, wherein the first direction is the thickness direction.

2. The scanning device according to claim 1, wherein the entire actuator is of a sheet structure, and the dimension of an end portion of the actuator in the width direction is greater than that in the thickness direction.

3. The scanning device according to claim 2, wherein a cross-section of the front end taken perpendicular to the length direction is rectangular, elliptical, or isosceles trapezoidal.

4. The scanning device according to claim 1, wherein the dimension of the actuator dimension of the actuator in the width direction gradually decreases forward along the length direction to form the front end; or
the dimension of the actuator in the width direction decreases smoothly forward along the length direction to form the front end.

5. The scanning device according to claim 1, wherein the optical fiber extends along the length direction, and is fixed to at least one of two main surfaces of the actuator that are opposite to each other along the thickness direction.

6. The scanning device according to claim 1, wherein the actuator has a through channel along the length direction, and the optical fiber is disposed through the through channel and fixedly connected to the actuator.

7. The scanning device according to claim 6, wherein the dimension of the front end in the width direction is less than that in the thickness direction, and the dimension in the width direction corresponds to a diameter of the optical fiber.

8. The scanning device according to claim 6, wherein the through channel is provided with a buffer structure at the front end, and the buffer structure comprises a tapered opening extending from a first position at a first distance from the through channel to a plane in which the front end is located to the plane in which the front end is located, so that an opening dimension of the through channel on the plane in which the front end is located is greater than that of the through channel at the first position.

9. The scanning device according to claim 1, wherein the light output end of the optical fiber extends beyond the front end of the actuator to form an optical fiber cantilever; or
the light output end of the optical fiber is flush with an end face of the front end of the actuator.

10. The scanning device according to claim 1, wherein at least part of the front end of the actuator is made of a second material, and the remaining part of the actuator is made of a first material.

11. The scanning device according to claim 1, wherein an axis of the light output end of the optical fiber is parallel to a central axis of the actuator along the length direction, wherein
the central axis is an axis passing through a geometric center and/or a center of mass of the actuator.

12. The scanning device according to claim 11, wherein a plane which is perpendicular to the width direction and in which the axis of the light output end of the optical fiber is located is coplanar with a plane which is perpendicular to the width direction and in which the central axis of the actuator along the length direction is located.

13. A scanning device, comprising a support base, an actuator, and an optical fiber fastened on the actuator, wherein the actuator comprises a back end and a front end, the back end is fixedly supported on the support base, and the front end is a free end; the actuator extends along a length direction towards a direction away from the back end, and a dimension of the actuator dimension of the actuator gradually decreases in at least one of a width direction and a thickness direction to form the front end;
the optical fiber extends along the length direction and is fixed to the actuator, and the thickness direction is a first direction; the actuator drives the optical fiber to vibrate in the first direction under the drive of a driving signal; and
the actuator is configured such that first-order and second-order bending mode natural frequencies in the first direction satisfy a set condition: Fp2>2 Fp1, wherein Fp1 is the first-order bending mode natural frequency of the actuator in the first direction; and Fp2 is the second-order bending mode natural frequency of the actuator in the first direction.

14. The scanning device according to claim 13, wherein the optical fiber extends beyond the front end of the actuator in the length direction, and the part extending beyond the actuator forms an optical fiber cantilever.

15. The scanning device according to claim 14, wherein the optical fiber is configured such that, when being fixed to the actuator, a ratio of a first-order bending mode resonance frequency of the optical fiber in the first direction to the first-order bending mode natural frequency of the actuator is within a first numerical range.

16. The scanning device according to claim 15, wherein the first numerical range is 0.9 to 0.98.

17. The scanning device according to claim 14, wherein an interval between a first-order bending mode natural frequency of the optical fiber and the first-order bending mode natural frequency of the actuator is within a second numerical range.

18. The scanning device according to claim 17, wherein the second numerical range is 2 kHz.

19. A scanning device, comprising a support base, an actuator, and an optical fiber fastened on the actuator, wherein the actuator comprises a back end and a front end, the back end is fixedly supported on the support base, and the front end is a free end; the actuator extends along a length direction towards a direction away from the back end, and a dimension of the actuator dimension of the actuator gradually decreases in at least one of a width direction and a thickness direction to form the front end;
the optical fiber extends along the length direction and is fixed to the actuator, and the thickness direction is a first direction; the actuator drives the optical fiber to vibrate in the first direction under the drive of a driving signal; the optical fiber is configured in the length direction at the front end of the actuator such that an end face of the optical fiber does not extend beyond an end face of the front end of the actuator; and
the actuator is configured such that first-order and second-order bending mode natural frequencies in the first direction satisfy a set condition: Fp2>2 Fp1, wherein Fp1 is the first-order bending mode natural frequency of the actuator in the first direction; and Fp2 is the second-order bending mode natural frequency of the actuator in the first direction.

20. A scanning display module, comprising at least the scanning device according to claim 1, a light source, and a control circuit, wherein
the light source outputs image light under control of the control circuit, and then the scanning device outputs the image light to implement scanning display.
